(19) United States
(12) Patent Application Publication
(10) Pub. No.: US 2015/0143486 A1
(43) Pub. Date: May 21, 2015

(54) Simplified Wi-Fi Setup

(71) Applicant: Vodafone Holding GmbH, Dusseldorf (DE)

(72) Inventor: Norman Hartmann, Dusseldorf (DE)

(73) Assignee: VODAFONE HOLDING GMBH, Dusseldorf (DE)

(21) Appl. No.: 14/535,652

(22) Filed: Nov. 7, 2014

(30) Foreign Application Priority Data
Nov. 15, 2013 (EP) EP13193146.1

(51) Int. Cl. H04L 29/06

(52) U.S. Cl. CPC H04L 63/083
USPC 726/6

(57) ABSTRACT

A method enables a simple and convenient secured connection to a secured wireless network by individual passwords generated by requesting clients, and a confirmation of the owner or operator (Wi-Fi hot spot) of the secured wireless network. Each requesting client automatically generates its own individual password. A routing device of the secured wireless network generates a request which is submitted to a confirmation authority such that the owner or operator of the secured wireless network can decide whether to agree to the request. An answer of the owner or operator submitted via the confirmation authority to the routing device enables the secured connection between the requesting client and the secured wireless network. The owner or operator of the secured wireless network does not need to remember a special password in order to enable the secure connection. The subject innovation includes such requesting clients, routing devices and systems.

### CROSS-REFERENCE TO RELATED APPLICATION

This application claims priority to European (EP) Patent Application No. EP 13193146.1, filed on Nov. 15, 2013, the contents of which are incorporated by reference as if set forth in their entirety herein.

### BACKGROUND

A standard procedure of setting up a secured connection between Wi-Fi-devices or clients like mobile devices as smart phones, laptops or the like or clients like internet radios, TVs or the like and a secured wireless networks usually requires that an owner of the secured wireless network sets a standard password on a router. This standard password is stored in the router and is used for all clients to set up a wireless connection between the client and the router. The standard password can be a router password that belongs to one specific router. The owner enters the password as soon as a new client is connected to the secured wireless network or the owner discloses the password to a user of a mobile device if the user agrees to connect the mobile device to the secured wireless network. The procedure does have several drawbacks. The owner has to remember the password causing either rather simple passwords or requiring a hardcopy of the password such that the password may become insecure. Further, the password has to be changed if the owner intends, for example, to deny the access of a previously accepted mobile device to the secured wireless network. In the latter case it may be necessary to manually log in again all other clients by entering the new password.

### SUMMARY

The subject innovation relates to a method of setting up a secured connection between a requesting client and a secured wireless network. The subject innovation further relates to a client, a routing device and a system to carry out the method or at least respective parts of the method.

A method of setting up a secured connection between a requesting client and a secured wireless network is provided. An individual password is generated by the requesting client. The individual password is submitted to a routing device. A confirmation for setting up the secured connection is requested based on the individual password from a confirmation authority. The secured connection is set up based on the individual password by the routing device after receiving the confirmation of the confirmation authority.

Secured wireless networks are, for example, encrypted by Wi-Fi Protected Access II (WPA2). WPA2 is a security standard to secure computers connected to a Wi-Fi network. Its purpose is to achieve complete compliance with the IEEE 802.11i standard, only partially achieved with the predecessor WPA, and to address a security flaw in the 128-bit “temporary key integrity protocol” (TKIP) in WPA by replacing it with the more sophisticated encryption algorithm “Counter Mode with Cipher Block Chaining Message Authentication Code Protocol” (CCMP). Details about WPA and WPA2 and related technologies can be found in the IEEE 802.11i standard which is incorporated by reference. Security protocols like WPA2 avoid access to the secured wireless network as long as, for example, no valid password is provided. The wireless network may be secured or encrypted by other security algorithms.

The subject innovation simplifies the process of providing a password by enabling the generation of an individual password, i.e., a client individual password by the requesting client. The subject innovation can simplify the process of setting up a secured connection between a client and a routing device, e.g., a WLAN-router owned by an individual or an operator, or a WLAN-router of an access point, by using the generated individual password for authentication of a requesting client in the secured wireless network and/or using the generated individual password for encrypting and decrypting the data traffic between the client and the access point.

The routing device may be a Wi-Fi hot spot or access point which is owned by the operator of the Wi-Fi hot spot or access point. This means the owner of the routing device can be an individual or a operator of the routing device, e.g., an operator of a Wi-Fi hot spot.

The individual password may, for example, be manually generated by the owner of a requesting client. A smartphone may, for example, ask the owner of the smartphone to provide a password by typing, scanning or speaking. Anyhow, manual generation of passwords may be cumbersome because the owner of the client provides it. Further, it may cause a security risk because human beings tend to provide simple passwords. In another embodiment, the password is automatically generated by the requesting client. The requesting client may in this case include a processor and a software tool running on the processor and/or by circuitry to automatically generate an individual password. The generated individual password may be a random or a pseudo-random password. Automatically generating an individual password may have the advantage that the owner of the requesting client is not generating the password. Further, the algorithm used to generate the password may include guidelines in order to provide individual passwords fulfilling high security standards like at least 10 characters, including special characters, including capitals and small letters, including letters and numbers, no names or words and the like. The individual password may be generated without consulting the user of the requesting client or alternatively after getting a confirmation from the user. A smartphone may, for example, display the name of a secured wireless network in range and ask the user of the smartphone e.g., by the display, whether a connection to the secured wireless is wanted. The owner of the smartphone confirms that a connection is wanted and the smartphone generates the individual password and submits the individual password to a routing device like a router of the secured wireless network. In an alternative case, a client, like an internet radio, detects a secured wireless network and immediately generates an individual password and submits the individual password to the routing device. Access to the secured wireless network is enabled if a confirmation authority confirms that the requesting client is allowed to connect to the secured wireless network.

In general, a generated individual password can be any password. The individual password can be generated, for example, by manually typing or entering any password into the requesting client or it can be generated by the requesting client in an fully or half automated way. The individual password may be unknown to the routing device and also unknown to the requesting client until it is generated in the requesting client and submitted or send to the routing device. Therefore, it is not necessary to store or attach the individual password in or at the requesting client or routing device before it is generated in the requesting client and submitted to the routing device. The individual password may be automatically generated by an application or software that is installed on the requesting client. The step of submitting or sending the generated individual password from the requesting client to the routing device may be performed wirelessly or by cable, i.e., wired.

The confirmation authority may be any device like a mobile phone, smartphone, desktop computer, laptop, server or the like integrated in the hardware or running as a software application enabling the owner or operator of the routing device or the secured wireless network to receive the request of the requesting client. The confirmation authority may alternatively or in addition be integrated in the routing device as an activation or confirmation element or an input device, e.g. a push button, microphone, scanning NFC tag, enter a code via a display or the like in to be activated or pushed e.g., by the owner of the routing device after receiving the individual password from the requesting client in order to confirm the request and to establish the secured connection. The owner of the routing device receives the request in case of a private secured wireless network and can decide whether he grants or denies access to the secured wireless network. A confirmation is submitted to the routing device if the request is confirmed by the confirmation authority. The routing device stores the individual password generated by the requesting client and enables access to the secured wireless network based on the individual password. It may thus be possible to securely connect a multitude of clients to one routing device based on different individual passwords generated by the requesting clients. It is not necessary that the owner of the routing device has to remember one of the individual passwords. The connection to the secured wireless network may be a nearly automatic process whereby only a confirmation of the confirmation authority is needed. It may even be possible that the requesting client does not provide any kind of identification to the confirmation authority. An owner of a secured wireless network may receive, for example, a request from a smartphone of visiting friend sitting next to him. The friend wants to get access to secured wireless network in order to get fast access to the internet. The owner of the secured wireless network confirms the request including only the message “Grant access to the secured wireless network?” by typing “Yes” using, for example, his smartphone as confirmation authority such that the corresponding routing device enables connection to the secured wireless network. In an alternative approach a physical element, e.g., a push button or the like being part of the routing device may be activated by the owner of the routing device. It may also be possible that the routing device sends the request and offers in parallel the opportunity to push the push button. Typically, an identification is provided with the request. The individual password is submitted to the routing device but the request submitted to the confirmation authority may not include the generated individual password in order to increase the security.

The request for confirmation for setting up the secured connection based on the individual password may be directly submitted by the routing device to the confirmation authority. The request for confirmation may be submitted wirelessly or in a wired way by the routing device to the confirmation authority. The confirmation authority e.g., a device owned and controlled by the owner of the routing device may be logged in to the secured wireless network such that the routing device submits the request to the owner and the owner can directly grant or deny access to the secured wireless network by the confirmation authority based on the generated individual password unknown to him. Alternatively or in addition a challenge center may be used in order to enable a confirmation by the same network technology or by different network technologies. This may be advantageous if the routing device may be associated to a Wi-Fi hot spot operated by a, for example, network provider as described in more detail below. The routing device may forward the request for confirmation for setting up the secured connection based on the individual password to the challenge center. The challenge center identifies the confirmation authority and requests the confirmation for setting up the secured connection based on the individual password from the confirmation authority. Request to access the secured wireless network may be forwarded via the internet or alternatively by mobile networks as GSM, UMTS, LTE or the like to the challenge center. The challenge center may be, for example, a server of a network provider in which the request of the routing device is matched to the confirmation authority which may be a mobile phone or smartphone of a customer of the network provider who is at the same time the owner of the secured wireless network. The request may, for example, be submitted to the smartphone of the owner of the routing device by Short Message Service (SMS) via the mobile network, via the internet by Emails or any other suitable network technology and messaging service. The owner of the routing device may confirm access to the secured wireless network by submitting an SMS to the server of the network provider and the server may submit an answer to the initial request to the routing device. The answer has to be in a format such that the routing device is able to understand the answer. The server of the network provider may thus convert the SMS provided by the confirmation authority meaning the smartphone of the owner of the routing device in a format which can be correctly interpreted by the routing device. Alternatively, it may be possible that the smartphone provides the confirmation directly to the routing device after receiving the requesting SMS from the server. The latter may, for example, be the case if the smartphone is logged in the secured wireless network. The smartphone may in this case convert the confirmation in a format which can be interpreted by the routing device or the routing device may interpret confirmations provided in different formats. The challenge center may thus enable an interaction of different network technologies in order to provide a simplified access to a secured wireless network.

The secured wireless network may include a network identification or network name, e.g., a Service Set Identifier (SSID) which may be used to indicate compatibility to the simplified connection method. The requesting client may identify compatible secured wireless networks such that the requesting client automatically selects one of the compatible secured wireless networks and generates the individual password if the requesting client is, for example, an internet radio. It may also be possible that the requesting client provides a list of secured wireless networks and indicates which of the networks is compatible with the simplified method such that the user of the requesting client can select one of the compatible networks in order to generate the individual password. The routing device may, in this case, provide a conventional secured wireless network in which a predefined router specific password, i.e., a routing device individual or access point device individual password is used to get access and additionally a secured wireless network which is enabled to grant access based on a client individual password generated by a requesting client after confirmation by a confirmation authority.

An identifier for identifying the requesting client may be added to the individual password in order to increase the security as already indicated above. The identifier may be the Media Access Control (MAC) address of the requesting client. The requesting client may thus be uniquely identified by the routing device and/or the challenge center. Alternatively or in addition the identifier may include a code for identifying the user of the requesting client or the name of the user of the requesting client. The identifier may be used in combination with the individual password to grant access to the secured wireless network if the individual password corresponds to the correct requesting client. A requesting client providing an individual password which was confirmed by the confirmation authority would not get access to the secured wireless network if, for example, no MAC address or the wrong MAC address is submitted in combination with the individual password. The identifier may include a component which can be used to check the trustworthiness of the requesting client and/or the user of the requesting client. An owner of the requesting client may, for example, be registered by a network provider. The network provider may also operate the challenge center. The confirmation authority may in a first approach be a part of the challenge center either in the form of specific hardware (processor, storage, etc. . . . ) or integrated as software application. The challenge center or the confirmation authority identifies in this case the requesting client by the identifier. The requesting client or the owner of the requesting client is registered in the confirmation authority in order to confirm the request. The confirmation authority automatically determines that the requesting client is allowed to set up a secured connection to the secured wireless network by the registration and submits the confirmation to the routing device. The routing device sets up the secured connection based on the individual password after receiving the confirmation. The confirmation is in this case automatically generated based on a registration of the requesting client and/or the user of the requesting client. It is thus possible to access, for example, Wi-Fi hot spots operated by a network provider offering access to the secured wireless network after, for example, registration to the corresponding service. The registered requesting client can access every Wi-Fi hot spot operated by the network provider based on each time newly generated individual passwords.

The challenge center may in case of an privately owned secured wireless network identify the requesting client or the user of the requesting client and submit e.g., an SMS to the confirmation authority including the request if the user of the requesting client is registered or if the user of the requesting client fulfills predefined security criteria. Further, it may be possible in all cases to encrypt the identifier by e.g., symmetric or asymmetric encryption whereby the encryption key is known by the requesting client and the decryption key is known by the challenge center if the requesting client or the user of the requesting client is registered at the challenge center. The user of the requesting client (e.g., smartphone) may, for example, use the encryption keys stored in the SIM, USIM or the like of his smartphone if the user of the smartphone uses the same network provider operating the challenge center. Alternatively, the identifier may be used to confirm the trustworthiness of the user of the requesting client by an independent service provider being different from the network provider. The identifier may enable the routing device and/or the challenge center and/or confirmation authority to provide support to the owner of the secured wireless network with respect to decision to confirm access based on the generated individual password.

The individual password may have to fulfill certain security criterions like at least 10 characters, including special characters, including capitals and small letters, including letters and numbers, no names or words and the like. The routing device may reject the individual password generated by the requesting client and request a new individual password. The routing device may provide a description of the security criteria such that the user of the requesting client can manually adapt the individual password. The description of the security criteria may alternatively or in addition be provided in a way that it can be automatically applied by the requesting client. The ability to reject an individual password increases the security because short and simple individual password can be avoided.

The secured connection between the requesting client and the secured wireless network may be terminated if a predefined condition is fulfilled. Termination means in this respect that a new confirmation of the confirmation authority is needed in order to enable further access to the secured wireless network. The new access to the secured wireless network may be based on the previously submitted individual password or a new individual password may be requested. Conditions triggering a termination may be, for example, time or time period of connection, whether a predefined data volume is exceeded, whether the connection between the secured wireless network and the requesting client is interrupted or the like. A predefined time of connection may be granted either automatically by the routing device or manually by the owner of the confirmation authority or the routing device. A time range of several minutes, hours or days may be granted. Alternatively or in addition termination of the connection may happen at a predefined daytime. A user of a requesting client may in this case only be allowed to access the secured wireless network between the confirmation by the confirmation authority at 5 pm and, for example, 6 pm of the same day. The latter may be used, for example, as a kind of child safety lock. Parents may be the owner of the confirmation authority and may be enabled to control access to the internet of their children. In this case the predefined condition may be coupled to an identifier or to a group of identifier (e.g., group my children). The identifier may even include a code indicating that the user of the requesting client belongs to a predefined group, for example, group of children at an age of 14 to 16. A request of a child of the owner or a child in general may in this case only be submitted to the confirmation authority within a predefined period of the day. Children may in this case only get the opportunity to access the secured wireless network between 6 pm and 8 pm. No request is submitted via the routing device or the challenge center outside this predefined time period and the connection may be automatically terminated at 8 pm in order to avoid excessive use of the internet. The latter condition may also be used with respect to other groups like, for example, visitors of a company. An alternative or additional predefined condition may be if the user of the requesting client tries to get access to predefined data. Such predefined data may be, for example, private data or more general data of a predefined security level. The data may be a web page or group of web pages. Termination of the connection to the secured wireless network may happen as soon as the user of the requesting client tries to access, for example, the group of webpages. The forbidden data or group of webpages may again be coupled to an identifier as described above. It may thus be possible to avoid, for example, access to forbidden data or webpages because the user of the requesting client needs to get a new confirmation by the confirmation authority after the connection was terminated. The owner of the secured wireless network may get information about the termination of the connection and the reason of termination via the routing device or the challenge center either upon termination or at the moment he receives a new request. The owner of the secured wireless network may define forbidden web pages by the routing device or the challenge center. The challenge center may enable more flexibility by offering, for example, different categories like children, shops and the like. The web pages which are forbidden are regularly updated based on the elected category. It may be necessary that the challenge center is operated by the service provider enabling access to the internet in order to control web access. Alternatively it may be that only access to the internet via the secured wireless network enabling access by individual passwords is handled via a service provider offering the service of a challenge center. The owner of the routing device may in this case use a standard access to the internet without any monitoring but user of requesting clients are monitored by the challenge center such that a termination can be triggered by the challenge center.

Termination of the connection between the requesting client and the secured wireless network may be triggered if the connection was interrupted. The individual password would expire as soon as an interruption of the connection is detected. Alternatively, the password expires after a predefined time of interruption in order to avoid unnecessary confirmation requests. Again it may be possible to combine this predefined condition with an identifier such that, for example, the individual password does not expire upon interruption of the connection for members of a predefined group of people (e.g., family) but expires for visitors. The owner of the secured wireless network is thus enabled to manage the people with access to the secured wireless network. Visitors may have to ask for confirmation to connect to the secured wireless network based on the generated individual password each time but members of the family may be allowed to connect to the secured wireless network based on an individual password generated and confirmed in the past. The different predefined condition of termination described above may be combined in any suitable way. Termination may be automatically initiated by the routing device if the predefined condition is met. Automatic termination may be supported by the challenge center by indicating to the routing device that a predefined condition is met. Alternatively, the owner of the secured wireless network may be automatically asked via the routing device or the challenge center by any suitable messaging service (Email, SMS . . . ) whether the connection shall be terminated. The connection is terminated and the individual password expires upon confirmation by the confirmation authority.

The owner of the secured wireless network may be interested to know who is enabled to get access to the secured wireless network by a confirmation based on a generated individual password. The owner of the secured wireless network may thus receive upon request or automatically information regarding requesting clients being allowed to access the secured wireless network. A list with requesting clients may, for example, be provided. The owner of the secured wireless network may withdraw allowance to set up a secured connection to the secured wireless network from requesting clients, which were allowed to set up a secured connection to the secured wireless network. The user of such requesting clients thus need a new confirmation based on a newly generated individual password by the confirmation authority as soon as they try to connect to the secured wireless network after the allowance has been withdrawn. An easy and convenient method of managing access to the secured wireless network may thus be enabled.

According to a further aspect of the subject innovation, a requesting client is provided. The requesting client automatically generates an individual password for enabling a setup to a secured wireless network. The requesting client like a smartphone, laptop, internet radio, TV or the like includes a processing device and a storing device. A computer program product may be stored in the storing device after, for example, downloading from a network. The computer program product includes code for producing the steps of
determining the presence of a secured wireless network;
generating an individual password which may fulfill predefined security criteria; and
submitting the individual password to a routing device of the secured wireless network when run on the processing device of the requesting client.
   The requesting client may especially be enabled by the computer program product to generate the individual password automatically. The requesting client may be enabled to access the secured wireless network based on the generated individual password. The requesting client may determine whether the secured wireless network or the routing device of the secured wireless network enables access to the secured wireless network based on the generated individual password. The requesting client may indicate compatibility of the secured wireless network to a user of the requesting client in order to generate the individual password by the user or to confirm automatic generation of the individual password. The requesting client may automatically adapt the security level of generated passwords if access to a secured wireless network is denied because the security of the previously generated individual password was too weak.

A routing device for enabling access to a secured wireless network by requesting clients based on individual passwords generated by the requesting clients is provided. The routing device receives an individual password generated by a requesting client. The routing device requests a confirmation for setting up a secured connection based on the individual password from a confirmation authority and to receive the confirmation from the confirmation authority. The secured connection between the secured wireless network and the requesting client is set up by the routing device based on the individual password after receiving the confirmation from the confirmation authority. The routing device may include a router memory, a router processor and a router interface. A computer program product may be stored in the router memory after, for example, downloading from a network. The computer program product includes code for
receiving a generated individual password from a requesting client;
generating a request for confirmation to set up a connection between the requesting client and a secured wireless network;
submitting the request to a confirmation authority; and
setting up the connection between the requesting client and the secured wireless network after receiving the confirmation from the confirmation authority.

The routing device enables a convenient and secure connection based on individual passwords generated by the requesting clients. No common password is needed in order to enable access to the secured wireless network. In addition, the routing device may provide access to a secured wireless network by a fixed password provided by the routing device or the owner of the routing device. Alternatively, or in addition, it may be possible that the routing device provides different secured wireless networks. The routing device may enable access to one of the secured wireless networks based on a conventional common password provided by the routing device or the owner of the secured wireless network and access to a different secured wireless network may be based on individually generated passwords provided by the requesting client in combination with the confirmation of the confirmation authority. The routing device may include the confirmation authority in an alternative approach. The confirmation authority may, in this case, be an input device like a push button, a microphone, an optical sensor, or any device which receives an input to confirm the request from the owner of the secured wireless network or someone else being able, and authorized, to confirm the request.

A system for enabling access to a secured wireless network by requesting clients based on individual passwords generated by the requesting clients is provided. The system includes a routing device and a challenge center. The routing device may be a routing device as described above. The routing device receives an individual password generated by a requesting client. The routing device requests a confirmation for setting up a secured connection based on the individual password from a confirmation authority via the challenge center. The challenge center forwards the request to a confirmation authority and receives the confirmation from the challenge center. The challenge center forwards the confirmation to the routing device. The routing device receives the confirmation from the challenge center and sets up the secured connection based on the individual password received from the requesting client. The challenge center may enable authentication of the requesting client, or the owner of the requesting client. The challenge center enables an interface between different network technologies such that the confirmation may be requested by an automatic call, a SMS, an Email, or any other messaging service suitable to transmit the request and the confirmation. The owner of the routing device may thus be enabled to grant access to the secured wireless network by any device being suited to receive the request, and to transmit the confirmation. A flexible and convenient management of the secured wireless network is thus enabled. The challenge center may include one or more challenge center processing devices and challenge center memory devices in order to enable the functionalities of the system.

### BRIEF DESCRIPTION OF THE DRAWINGS

These and other aspects of the subject innovation will be apparent from and elucidated with reference to the embodiments described hereinafter.

The subject innovation will now be described, by way of example, with reference to the accompanying drawings.

In the drawings:

FIG. 1 is a block diagram of a first embodiment.

FIG. 2 is a block diagram of a second embodiment.

FIG. 3 is a block diagram of a third embodiment.

FIG. 4 is a block diagram of a fourth embodiment.

FIG. 5 is a block diagram of a fifth embodiment.

FIG. 6 is a process flow diagram of a method for accessing a secured wireless network based on an individually generated password.

FIG. 7 is a block diagram of a requesting client.

FIG. 8 is a block diagram of a routing device.

In the Figures, like numbers refer to like objects throughout. Objects in the Figures are not necessarily drawn to scale.

### DETAILED DESCRIPTION OF SPECIFIC EMBODIMENTS

Various embodiments of the subject innovation will now be described with reference to the Figures.

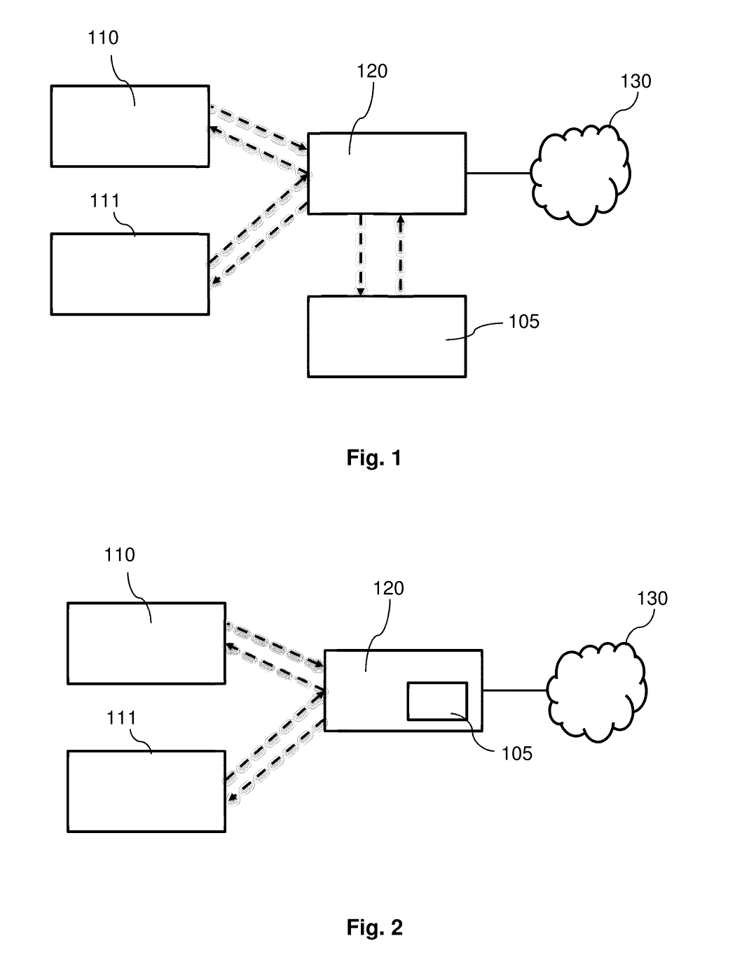

FIG. 1 shows a principal sketch of a first embodiment. A first requesting client 110 which may be smartphone and a second requesting client 111 which may be an internet radio trying to access a secured wireless network via a routing device 120. The first requesting client 110 determines the presence of the secured wireless network and checks by the SSID of the secured wireless network whether an access to the secured wireless network by an individual password is possible. The first requesting client 110 indicates to a user of the first requesting client 110 by a display that he can log in in the detected secured wireless network based on an individual password and asks the user whether he intends to generate the individual password by an input unit of the first requesting client 110 or whether the individual password shall be generated automatically. The user decides that the individual password is automatically generated by the first requesting client 110 because the security level of the secured wireless network causes complicated individual passwords. The first requesting client 110 automatically generates a first individual password and sends the first individual password, together with an identifier including the name of the user of the first requesting client 110, or the MAC address of the requesting client 110, to the routing device 120. The routing device 120 receives the first individual password and the name of the user or the MAC address, and generates a request for setting up a secured connection based on the first individual password from a confirmation authority 105 including the name of the user or the MAC address of the first requesting client 110, and submits the request to the confirmation authority 105, which is, at this moment in time, the desktop of the owner of the secured wireless network, which is connected to the routing device 120 by a cable connection. The request is indicated to the owner of the wireless network by a message, “Grant access to the secured wireless network to the user XY of the first requesting client?” The owner of the secured wireless networks selects the option that the user of the first requesting client 110 is allowed to access the secured wireless network for two hours, and clicks the “Yes” button in order to confirm the request. The confirmation and the corresponding time limitation are transferred, via the cable connection, to the routing device 120, which establish a secured connection between the secured wireless network and the first requesting client 110 by the first individual password for the following two hours such that the user of the first requesting client can access a requested data resource 130 (e.g., internet) via the secured wireless network. The secured connection is terminated and the individual password expires after the two hours such that a new request including a new individual password and a new confirmation would be needed in order to establish a new secured connection. The owner of the secured wireless networks positions, within the two hours, the second requesting client 111 (internet radio), and switches the second requesting client 111 on. The second requesting client 111 detects the secured wireless layer, automatically generates a second individual password, and submits the second individual password together with its MAC address to the routing device 120. The routing device 120 receives the second individual password and the MAC address, and generates a request for setting up a secured connection based on the second individual password from the confirmation authority 105. The routing device submits the request to all devices which are used by the owner of the secured wireless network as confirmation authority 105. The owner is next to the second requesting client 111, and thus does not see the request submitted to the desktop, but an activated tablet computer of the owner is next to the owner, and logged in the secured wireless network. The tablet computer is one of the devices which are listed in the routing device 120 as potential confirmation authorities 105. The tablet computer receives the request via the secured wireless network. The request is indicated to the owner of the wireless network by a message, “Grant access to the secured wireless network to the internet radio type Z?” The owner of the secured wireless networks selects the option that the second requesting client 110 is allowed to access the secured wireless network without restrictions and clicks the “Yes” button in order to confirm the request. The confirmation is transferred, via the secured wireless network, to the routing device 120, which establishes a secured connection between the secured wireless network and the second requesting client 111 by the second individual password provided by the internet radio such that the internet radio can receive radio programs via the secured wireless network.

FIG. 2 shows a principal sketch of a second embodiment. The confirmation authority 105 is, in this case, integrated in the routing device 120. The confirmation authority 105 may, in this case, be an input device like a push button, a microphone, an optical sensor or any device which can receive an input signal e.g., from the owner of the secured wireless network. The push button may, for example, include a signaling lamp indicating that a confirmation for setting up the secured connection based on the individual password is requested. The owner of the secured wireless network pushes the button in order to confirm the request such that the secured connection is set up based on the individual password. Alternatively, or in addition, an acoustic signal may be provided via a loudspeaker associated to a microphone acting together with hardware and/or software as confirmation authority. The acoustic signal indicates that a confirmation for setting up the secured connection based on the individual password is requested. The owner may say an acoustic order which may be a word like “accept” in order to confirm the request such that the secured connection is set up based on the individual password.

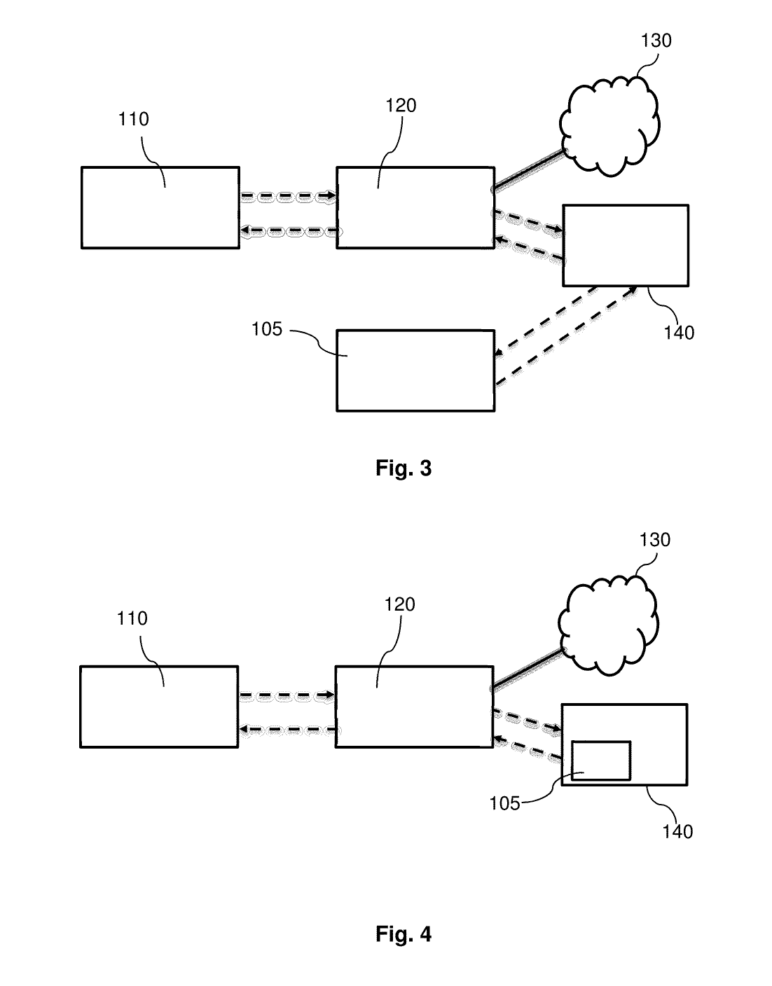

FIG. 3 shows a principal sketch of a third embodiment. A requesting client 110, a laptop of a user, determines the presence of a secured wireless network. The requesting client 110 determines, based on the SSID of the secured wireless network, that an authentication by a challenge center 140 is needed in order to get access to the secured wireless network. The requesting client 110 automatically detects that the user of the requesting client 110 is registered in the respective challenge center 140, automatically generates an individual password, and sends the individual password together with an identifier in an encrypted form, the name of the user of the requesting client 110 to a routing device 120 of the secured wireless network. The routing device 120 receives the individual password and the identifier, and generates a request for setting up a secured connection based on the individual password from a confirmation authority 105. The routing device forwards the request together with the identifier via a cable connection to the challenge center 140. The challenge center 140 decrypts the identifier, determines that the user of the requesting client 110 is trustworthy, and determines the owner of the secured wireless network by an address of the routing device 120. The challenge center 140 converts the request to an SMS message and submits the SMS including the request via a mobile network to the corresponding confirmation authority 105, which is stored in the challenge center 140. The confirmation authority 105 is a smartphone of the owner of the secured wireless network. The smartphone receives the request and displays the SMS to the owner of the secured wireless network. The owner of the secured wireless network submits a confirmation SMS to the challenge center 140. The confirmation SMS is converted in a format which can be interpreted by the routing device 120 and forwarded to the routing device 120. The routing device 120 establishes a secured connection between the secured wireless network and the requesting client 110 by the individual password such that the requesting client can access the requested data resource 130.

FIG. 4 shows a principal sketch of a fourth embodiment. The fourth embodiment is especially suited for Wi-Fi hot spots which are not owned by a human being, but offer a service of a network provider which may also operate mobile networks as GSM, UMTS, and LTE. A requesting client 110, e.g., a smartphone of a user, determines the presence of a secured wireless network. The requesting client 110 determines, based on the SSID of the secured wireless network, that a secured connection to the secured wireless network can be established after receiving a confirmation of a confirmation authority which is, in this case, implemented in a challenge center 140. The requesting client 110 automatically detects that the user of the requesting client 110 is registered in the respective challenge center 140, automatically generates an individual password, and sends the individual password together with an identifier including the MAC address of the requesting client 110 to a routing device 120 of the secured wireless network. The MAC address may be encrypted. The routing device 120 receives the individual password and the identifier, and generates a request for setting up a secured connection based on the individual password from the confirmation authority 105. The routing device 120 forwards the request together with the identifier via a wireless connection, e.g., a GSM, UMTS, LTE, WLAN or wired connection, e.g., DSL, fiber optics to the challenge center 140. The challenge center 140 may decrypt the identifier, and forwards the decrypted identifier, including the MAC address of the requesting client, to the confirmation authority, which may be a part of the challenge center 140 either in the form of specific hardware (processor, storage, etc.), or integrated as software application. The confirmation authority 105 identifies the requesting client 110, for example, by the MAC address which is registered in the confirmation authority 105. The confirmation authority 105 automatically determines that the requesting client 110 is allowed to set up a secured connection to the secured wireless network by the registration and submits the confirmation to the routing device 120. The routing device 120 sets up the secured connection based on the individual password after receiving the confirmation. The confirmation is in this case automatically generated based on a registration of the requesting client 110 and/or the user of the requesting client 110.

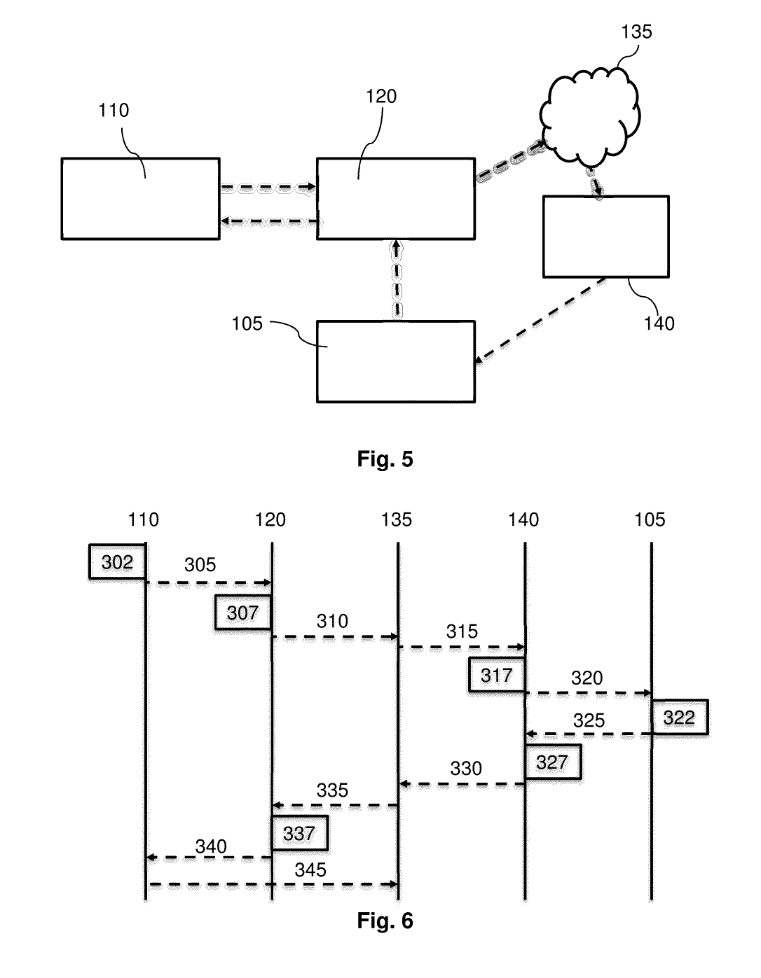

FIG. 5 shows a principal sketch of a fifth embodiment. A requesting client 110, a smartphone of a user, determines the presence of a secured wireless network. The requesting client 110 automatically generates an individual password, and sends the individual password, together with an identifier identifying the user of the requesting client 110, to a routing device 120 of the secured wireless network. The message with the individual password includes the information that the user request access to some specific data files saved in the desktop computer of the owner of the secured wireless network. The routing device 120 receives the individual password and the identifier, and generates a request for setting up a secured connection based on the individual password from a confirmation authority 105 including the identifier, and forwards the request together with the identifier via the internet 135 to the challenge center 140. The challenge center 140 determines the owner of the secured wireless network. The challenge center 140 converts the request to an Email message and submits the Email including the request via a mobile network to the corresponding confirmation authority 105 which is stored in the challenge center 140. The confirmation authority 105 is a laptop of the owner of the secured wireless network. The laptop receives the request and displays the Email to the owner of the secured wireless network. The owner of the secured wireless network checks to which data files access is requested and selects the data files to which he wants to grant access. The laptop is logged in to the secured wireless network and directly submits in a suitable format which can be interpreted by the routing device 120 the confirmation to the routing device 120 including the list of released data files. The routing device 120 establishes a secured connection between the secured wireless network and the requesting client 110 by the individual password such that the requesting client 110 can access the released data files.

FIG. 6 shows a process flow of getting access to a secured wireless network based on an individually generated password. A requesting client detects a secured wireless network. In step 302, an individual password is automatically generated by the requesting client 110. In step 305, the individual password is submitted to a routing device 120. In step 307, a request of confirmation for setting up a secured connection based on the individual password is generated by the routing device 120. In step 310, the request is forwarded together with an address of a challenge center 140 to the Internet 135. In step 315, the request is forwarded to the challenge center 140. In step 317, a SMS including the request is generated in the challenge center 140, and a confirmation authority 105 is determined based on an address or identification of the routing device 120. The SMS is submitted in step 320 to the confirmation authority 105. The owner of the secured wireless network initiates the generation of a confirmation SMS in step 322. The confirmation SMS is forwarded to the challenge center 140 in step 325. In step 327, the confirmation is prepared in the challenge center 140 in a format which can be interpreted by the routing device 120. In step 330, the confirmation is forwarded to the Internet 135, and in step 335, further forwarded to the routing device 120. In step 337, the individual password is released by the routing device 120 for establishing a secured connection to the internet 135 via the secured wireless network. In step 340, the secured connection is released by the routing device, and in step 345, the Internet is accessed by the requesting client 110 via the secured wireless network based on the individual password.

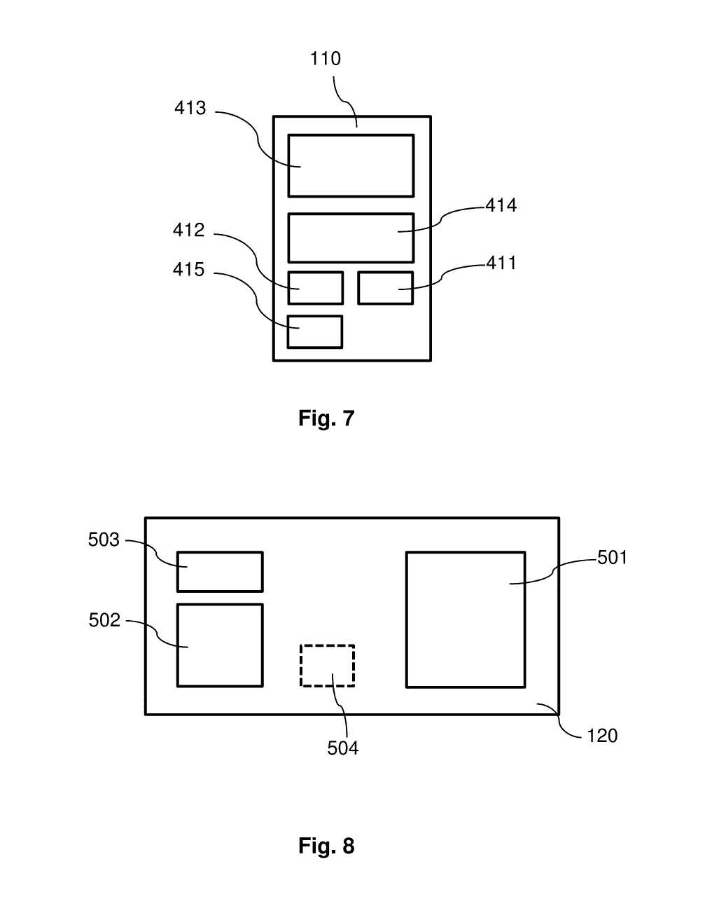

FIG. 7 shows a principal sketch of a requesting client 110. The requesting client 110 can be a mobile phone or a tablet including a main processor 411, a radio interface 412, a display 413, an input unit 414 and a secure element 415. Program code that enables a connection to secured wireless network, based on an individually generated password as described above, is stored in the secure element 415. The secure element 415 is a SIM, USIM, or the like, enabling a connection to mobile networks like GSM, UMTS, LTE or the like. The secure element further enables encryption and decryption such that an identifier may be encrypted by the secure element 415. A secured wireless network may be detected via the radio interface 412. An individual password may be generated by the owner of the requesting client 110 by the input unit and the display. Alternatively, it may be automatically generated by either the secure element 415 or the main processor 411. The individual password is submitted via the radio interface 412 to a routing device 120 of the secured wireless network in order to establish a secure connection by the individual password.

FIG. 8 shows a principal sketch of a routing device 120. The routing device 120 includes a router memory 501, a router processor 502 and a router interface 503. The address of a challenge center 140 and of a confirmation authority 105 are stored in the router memory 501. Further, program code is stored in the router memory 501 enabling the router processor 502 to request a confirmation for setting up a secured connection to the secured wireless network based on the individual password received via the router interface 503 from a confirmation authority 105, and setting up the secured connection based on the individual password after receiving the confirmation of the confirmation authority 105. The router interface 503 enables connection to the Internet 135, the secured wireless network and optionally mobile networks as GSM, UMTS, LTE or the like.

The routing device 120 may optionally include a push button 504 which may act as confirmation authority 105. The program code stored in the router memory 501 may enable, in this case, the router processor 502 to generate the request for confirmation by activating the push button 504. The, for example, owner of the routing device 120, confirms the request by pushing the push button 504. The program code enables the router processor 502 to set up the secured connection based on the individual password after pushing the push button 504, and to deactivate the push button 504 until a further individual password is received via the router interface 503.

The described method enables a simple and convenient secured connection to a secured wireless network by individual passwords generated by requesting clients and a confirmation of the owner of the secured wireless network. Each requesting client automatically generates its own individual password. A routing device of the secured wireless network generates a request which is either directly or indirectly submitted to a confirmation authority such that the owner of the secured wireless network can decide by the confirmation authority whether to agree to the request or not. An answer of the owner, submitted via the confirmation authority to the routing device, enables the secured connection between the requesting client and the secured wireless network based on the individual password generated by the requesting client. The owner of the secured wireless network does not need to remember a special password in order to enable the secure connection. Further, no new password is to be created if a requesting client shall be excluded from the secure connection. Access is denied for this special requesting client based on the corresponding individual password without affecting access right of other requesting clients.

While the subject innovation has been illustrated and described in detail in the drawings and the foregoing description, such illustration and description are to be considered illustrative or exemplary, and not restrictive.

From the present disclosure, other modifications will be apparent to persons skilled in the art. Such modifications may involve other features which are already known in the art and which may be used instead of or in addition to features already described herein.

Variations to the disclosed embodiments can be understood and effected by those skilled in the art, from a study of the drawings, the disclosure and the appended claims. In the claims, the word “including” does not exclude other elements or steps, and the indefinite article “a” or “an” does not exclude a plurality of elements or steps. The mere fact that certain measures are recited in mutually different dependent claims does not indicate that a combination of these measures cannot be used to advantage.

Any reference signs in the claims should not be construed as limiting the scope thereof.

What is claimed is:

1. A method of setting up a secured connection between a requesting client and a secured wireless network, comprising:
generating an individual password by the requesting client;
submitting the individual password to a routing device;
requesting a confirmation for setting up the secured connection based on the individual password from a confirmation authority; and
setting up the secured connection based on the individual password by the routing device after receiving the confirmation of the confirmation authority.

2. The method according to claim 1, wherein the individual password is automatically generated.

3. The method according to claim 1, comprising:
forwarding the request for confirmation for setting up the secured connection based on the individual password to a challenge center;
identifying the confirmation authority by the challenge center; and
requesting the confirmation for setting up the secured connection based on the individual password from the confirmation authority by the challenge center.

4. The method according to claim 1, wherein the method includes the further steps of:
identifying the confirmation authority by the routing device; and
requesting the confirmation for setting up the secured connection based on the individual password from the confirmation authority by the routing device.

5. The method according to claim 1, comprising:
identifying the secured wireless network; and
generating the individual password by the requesting client depending on the identified secured wireless network.

6. The method according to claim 1, comprising:
adding an identifier for identifying the requesting client to the individual password;
determining an identification of the requesting client based on the identifier; and
adding the identification of the requesting client to the request for confirmation for setting up the secured connection.

7. The method according to claim 6, wherein the identification of the requesting client is determined by the challenge center.

8. The method according to claim 6, wherein the identification of the requesting client is determined by the routing device.

9. The method according to claim 1, comprising:
terminating the secured connection between the requesting client and the secured wireless network if a predefined condition is fulfilled.

10. The method according to claim 9, wherein the secured connection between the requesting client and the secured wireless network is automatically terminated by the routing device after fulfilling the predefined condition.

11. The method according to claim 10, comprising:
informing by the routing device the confirmation authority that the predefined condition is fulfilled; and
terminating the secured connection between the requesting client and the secured wireless network if the termination is confirmed by the confirmation authority.

12. A requesting client to generate an individual password for enabling a secured connection by a routing device to a secured wireless network based on the individual password.

13. A routing device to receive an individual password generated by a requesting client, the routing device requesting a confirmation for setting up a secured connection based on the individual password from a confirmation authority, the routing device receiving the confirmation from the confirmation authority, and the routing device setting up the secured connection based on the individual password after receiving the confirmation from the confirmation authority.

14. A routing device according to claim 13, wherein the routing device includes the confirmation authority, and wherein the confirmation authority is an input device which receives an input to confirm the request.

15. A system including a routing device and a challenge center, the routing device receiving an individual password generated by a requesting client, the routing device requesting a confirmation for setting up a secured connection based on the individual password from a confirmation authority via the challenge center, the challenge center forwarding the request to a confirmation authority, the challenge center receiving the confirmation from the confirmation authority, and the challenge center forwarding the confirmation to the routing device, the routing device receiving the confirmation from the challenge center, and the routing device setting up the secured connection based on the individual password.
